(19) United States
(12) Patent Application Publication
(10) Pub. No.: US 2026/0364411 A1
(43) Pub. Date: Nov. 19, 2026

(54) CUSTOM-MADE GOLF SHAFT AND METHOD FOR MANUFACTURING GOLF SHAFT

(71) Applicant: I.S.T Corporation, Otsu-shi, Shiga (JP)

(72) Inventors: Masayuki SAKANE, Kyoto (JP); Satoshi UEHARA, Shiga (JP)

(21) Appl. No.: 19/480,547

(22) PCT Filed: Jul. 4, 2024
(86) PCT No.: PCT/JP2024/024177

§ 371 Date: Oct. 31, 2025

(30) Foreign Application Priority Data
Jul. 26, 2023 (JP) 2023-121735

(51) Int. Cl. A63B 53/00; A63B 53/12; A63B 102/32

(52) U.S. Cl. CPC A63B 53/005; A63B 53/12; A63B 2102/32

(57) ABSTRACT

An object of the present invention is to efficiently provide a golf shaft that is likely to suit each individual golf player without requiring a great deal of effort or time. In a method of manufacturing a golf shaft according to the present invention, 1) a second club is selected from a plurality of second clubs, the second club having a second shaft with characteristics most similar to the characteristics of the first shaft of the first club, 2) the flex of the shaft to be manufactured is tentatively determined based on the movement speed of the second head measured in test-hitting with the selected second club, 3) one second club is selected from the plurality of second clubs based on the trajectory of the second head determined in test-hitting with the plurality of second clubs having the tentatively determined flex, 4) characteristics of the shaft to be manufactured are determined based on the behavior of the second shaft determined in test-hitting with the selected one second club and characteristic information of the second club, and finally 5) the shaft to be manufactured is manufactured using the information on the characteristics of the shaft to be manufactured that has been determined.

### TECHNICAL FIELD

The present invention relates to a method of manufacturing a golf shaft, and more particularly to a method of manufacturing a custom-made golf shaft.

### BACKGROUND ART

In recent years, there are various models of golf shafts with different bending characteristics or the like. In addition, each model often has a lineup with different specifications (for example, flex, torque, weight, or the like). Further, cases have been increasing in which when a person who enjoys golf (hereinafter this may be referred to as “golf player”) purchases a golf shaft or golf club, the golf player goes to a store or the like that has swing analysis devices, trajectory measurement devices, or the like installed and has a fitter on staff, repeatedly test-hits a golf ball with multiple golf clubs available at the store (multiple golf shafts of various models and specifications with grips and heads attached), and then purchases the club recommended by the fitter based on the measurement data from the swing analysis device, trajectory measurement device, or the like during the test-hits (see, for example, JP2022-023015 A, etc.).

### PRIOR ART DOCUMENT

### Patent Documents

Patent Document 1: JP2022-023015 A

### DISCLOSURE OF INVENTION

### Technical Problem

However, currently, there are a wide variety of golf shaft models and specifications, and if a golf player wants to find a golf club or golf shaft that is truly suited to him or her, the golf player will need to try out a considerable number of clubs, which will require the golf player to expend a great deal of effort and time. In some cases, the golf player may not be able to find a golf shaft that suits him or her, and may end up wasting a lot of effort and time.

An object of the present invention is to efficiently provide a golf shaft that will suit each individual golf player without requiring the above-mentioned great amount of effort and time.

### Solution to Problem

A method for manufacturing a custom-made golf shaft (hereinafter, it may be simply referred to as an “OMG shaft”) according to a first aspect of the present invention includes a characteristic determination step, a first selection step, an HS measurement step, a tentative flex determination step, a head trajectory determination step, a second selection step, a shaft behavior determination step, a first determination step, and a manufacturing step. The characteristic determination step determines a characteristic of a first shaft of a first golf club having the first shaft. The first selection step selects a second golf club having a second shaft having characteristics most similar to those of the first shaft from a plurality of second golf clubs having second heads and second shafts having characteristics different from each other.

The HS measurement step measures a movement speed of the second head when a golf ball is hit with the second golf club selected in the first selection step. The tentative flex determination step tentatively determines a flex of a shaft to be manufactured based on the movement speed of the second head measured in the HS measurement step. The head trajectory determination step determines a trajectory of the second head of each of a plurality of second golf clubs (hereinafter referred to as the “21st golf clubs”) when the golf ball is hit with each of the plurality of second golf clubs each having a flex corresponding to the flex tentatively determined in the flex tentative determination step. The second selection step selects one 21st golf club (hereinafter referred to as a “22nd golf club”) from the plurality of 21st golf clubs based on the trajectory of the second head determined in the head trajectory determination step. The shaft behavior determination step determines a behavior of the second shaft of the 22nd golf club (trajectory of the second shaft over time) when a golf ball is hit with the 22nd golf club. The first determination step determines the flex, torque, three-point stiffness, weight, shape and center of gravity position of the shaft to be manufactured based on the behavior of the second shaft of the 22nd golf club determined in the shaft behavior determination step and characteristic information of the 22nd golf club. The manufacturing step manufactures the shaft to be manufactured using the information on the flex, torque, three-point stiffness, weight, shape, and center of gravity position of the shaft to be manufactured determined in the first determination step.

This method of manufacturing the OMG shaft allows for manufacturing a golf shaft that is likely to suit each individual golf player through the above-described steps. Thus, utilizing the method of manufacturing the OMG shaft allows for efficiently providing golf shafts that are likely to suit individual golf players without spending a lot of time and effort on test shots, or the like.

A method for manufacturing an OMG shaft according to a second aspect of the present invention is the method for manufacturing an OMG shaft according to the first aspect, further including an input step. The input step inputs information on the characteristics of the first golf club determined in the characteristic determination step into a computer. In the first selection step, information on the characteristics of the first shaft is approximately collated with a first database that stores information on the characteristics of the second shaft in association with identification information of the second shaft, thereby outputting identification information of a second golf club having a second shaft with characteristics most similar to those of the first shaft.

In this method of manufacturing an OMG shaft, the first selection step is performed automatically by inputting information on the characteristics of the first golf club into a computer. This allows for quickly and accurately determining the second golf club having the second shaft with characteristics most similar to those of the first shaft.

A method for manufacturing an OMG shaft according to a third aspect of the present invention is the method for manufacturing an OMG shaft according to the first or the second aspect, in which in the HS measurement step, information on the movement speed of the second head is stored in a storage device. Note that this storage device may be built into the computer described above, may be externally attached to the computer, or may be built into or externally attached to a computer that is communicatively connected to the computer via a network or the like. In the tentative flex determination step, the information on the movement speed is collated with a second database that stores information on a range of the movement speed in association with the information on the flex, thereby outputting the information on the flex of the shaft to be manufactured.

In this method of manufacturing the OMG shaft, the flex provisional determination step is performed automatically. This allows the flex of the shaft to be manufactured to be tentatively determined quickly and accurately.

A method for manufacturing an OMG shaft according to a fourth aspect of the present invention is the method for manufacturing an OMG shaft according to any one of the first to third aspects, in which in the second selection step, the identification information of the 22nd golf club is collated with a third database that stores information on the three-point stiffness of the second shaft in association with identification information of the second golf club, thereby outputting the information on the three-point stiffness of the shaft to be manufactured.

In this method of manufacturing an OMG shaft, the identification information of the second shaft of the 22nd golf club is collated with the third database, thereby outputting information on the three-point stiffness of the shaft to be manufactured. This allows for easily obtaining information on the three-point stiffness of the shaft to be manufactured.

A method for manufacturing an OMG shaft according to a fourth aspect of the present invention is the method for manufacturing an OMG shaft according to any one of the first to fourth aspects, further includes a third selection step, and a second determination step. In the third selection step, information on the flex, torque, three-point stiffness, weight, shape and center of gravity position of the shaft to be manufactured is approximately collated with a fourth database that stores manufacturing information on the second shaft and a custom-made golf shaft manufactured in the past (hereinafter referred to as “manufactured golf shaft”) in association with information on the flex, torque, three-point stiffness, weight, shape and center of gravity position of the second shaft and the manufactured golf shaft, thereby outputting manufacturing information on the second shaft or the manufactured golf shaft as an approximate model shaft of the shaft to be manufactured. A second determination step determines a method of manufacturing the shaft to be manufactured by using manufacturing information of the second shaft or the manufactured golf shaft as an approximate model shaft of the shaft to be manufactured. Then, in the manufacturing step, the shaft to be manufactured is manufactured based on the method of manufacturing the shaft to be manufactured determined in the second determination step.

In this method for manufacturing an OMG shaft, manufacturing information of a second shaft or the manufactured golf shaft as an approximate model shaft of the shaft to be manufactured is outputted in the third selection step, and the method of manufacturing the shaft to be manufactured is determined using the manufacturing information of the second shaft or the manufactured golf shaft as an approximate model shaft of the shaft to be manufactured in the second determination step.

This allows for quickly and easily designing the shaft to be manufactured.

A method for manufacturing a golf shaft according to a sixth aspect of the present invention includes an output step, a determination step, and a manufacturing step. In the output step, information on the flex, torque, three-point stiffness, weight, shape and center of gravity of a golf shaft to be manufactured (hereinafter referred to as the “shaft to be manufactured”) is approximately collated with a database that stores manufacturing information on golf shafts manufactured in the past (hereinafter referred to as the “manufactured golf shaft”) in association with information on the flex, torque, three-point stiffness, weight, shape and center of gravity of the manufactured golf shaft, thereby outputting manufacturing information on the manufactured golf shaft as an approximate model shaft of the shaft to be manufactured. The determination step determines a method of manufacturing the shaft to be manufactured using manufacturing information of the manufactured golf shaft as an approximate model shaft of the shaft to be manufactured. The manufacturing step manufactures the shaft to be manufactured based on the method of manufacturing the shaft to be manufactured determined in the determination step.

In this method for manufacturing a golf shaft, in the output step, information on the flex, torque, three-point stiffness, weight, shape, and center of gravity position of the shaft to be manufactured is approximately collated with the database, and manufacturing information on the manufactured golf shaft as an approximate model shaft of the shaft to be manufactured is outputted, and in the determination step, the manufacturing information on the manufactured golf shaft as an approximate model shaft of the shaft to be manufactured is used to determine a method of manufacturing the shaft to be manufactured, and in the manufacturing step, the shaft to be manufactured is manufactured based on the method manufacturing the shaft to be manufactured determined in the determination step. This allows for a smooth flow from designing to manufacturing of the shaft to be manufactured.

### BRIEF DESCRIPTION OF DRAWINGS

FIG. 1 is a schematic diagram showing a system according to an embodiment of the present invention.

FIG. 2 is a schematic block diagram showing the configuration of a first computer according to an embodiment of the present invention.

FIG. 3 is a schematic diagram of programs, data, or the like stored in an auxiliary memory of the first computer according to an example embodiment of the present invention.

FIG. 4 is a schematic diagram of a second golf club characteristic information management table constituting a first database of the first computer according to an embodiment of the present invention.

FIG. 5 is a schematic diagram of a head trajectory information management table for each hitter that constitutes the first database of the first computer according to an embodiment of the present invention.

FIG. 6 is a schematic diagram of a manufacturing history table constituting a second database of a second computer according to an embodiment of the present invention.

FIG. 7 is a diagram showing trajectories of motion capture sensors when a golf club incorporating a second shaft to which the motion capture sensors have been attached is swung. Note that the trajectories labeled P1 to P7 in the figure represent the respective trajectories of each motion capture sensor.

FIG. 8 is a graph showing the change in the movement speed of the motion capture sensors when the golf club incorporating the second shaft to which the motion capture sensors have been attached is swung. Note that the horizontal axis of the figure represents time, and the vertical axis represents the movement speed of the motion capture sensors.

### REFERENCE SIGNS LIST

110 First Computer (Computer)
DB First database (first database, second database, third database)

### DESCRIPTION OF EMBODIMENTS

### Method for Manufacturing a Custom-Made Golf Shaft According to an Embodiment of the Present Invention

A custom-made golf shaft (hereinafter this may be simply referred to as an “OMG shaft”) according to an embodiment of the present invention is manufactured through a characteristic determination step, a first selection step, an HS measurement step, a tentative flex determination step, a head trajectory determination step, a second selection step, a shaft behavior determination step, a shaft specification determination step (corresponding to the “first determination step” in claim 1), a manufacturing specification determination step (corresponding to the “second determination step” in claim 5), and a manufacturing step. These steps will be described in detail below. It is desirable that the steps from characteristic determination step to the shaft specification determination step be performed with a fitter accompanying a golf player (hereinafter this may be referred to as the “hitter”). The manufacturing specification determination step is preferably performed by a golf shaft manufacturing specification determiner, and the manufacturing step is preferably performed by a golf shaft manufacturer. Additionally, each step may be performed manually while recording measurement values, or it may be performed semi-automatically using a computer with measurement values entered either manually or automatically.

### (1) Characteristic Determination Step

In the characteristic determination step, the characteristics of a first shaft of a first golf club having the first shaft are determined. Note that the first golf club is preferably a golf club that a prospective purchaser of the OMG shaft primarily uses at the time, but may be any other golf club. The characteristics of the first golf club include (a) the weight balance of the golf club, (b) the weight, flex, torque, flex point, three-point stiffness, flex point coefficient, C/B value, T/C value and frequency of the first shaft, and (c) the weight, volume and center of gravity position of a first head. Note that the weight balance of a golf club refers to, for example, indicating in which region the weight balance point is located, and can be expressed, for example, as follows: . . . , C8, C9, D0, D1, D2, . . . , where the head side is divided into five regions, A, B, C, D, and E in the order from the lightest side to the heaviest side, and furthermore each of the regions A, B, C, D, and E is divided into 10 regions, 0 to 9 in the order from the lightest side to the heaviest side. The weight of a shaft is a weight after cutting to the desired length. The flex indicates the stiffness of a shaft, and can be expressed as A, LL, L, R, SR, S, SX, X, XX, etc., in the order from softest to hardest. Note that the flex may be relative within the same model. The torque quantifies the ease of rotational movement along the axis of the shaft and is typically expressed as a value between 2.0 and 7.0. The flex point refers to the approximate location on the shaft where it bends most easily; for example, the flex point is described as tip-heavy, tip-to-mid, mid, mid-to-butt, or butt-heavy, with the head side of the shaft set as the tip end for reference. Note that the flex point is also called the kick point. When two points that are centered on a point 250 mm away from the tip of the shaft and are located 150 mm to either side of the point 250 mm away from the tip, two points that are centered on the center position of the shaft and are located 150 mm to either side of the point 250 mm away from the center position, and two points that are centered on a point 250 mm away from the rear end of the grip and are located 150 mm to either side of the point 250 mm away from the rear end of the grip are fixed, three-point stiffness refers to the load required to depress (i.e., bend) each of the three points, that is, the point 250 mm away from the tip of the shaft, the center position of the shaft, and the point 250 mm away from the rear end of the grip, by 2 mm when loading them. For ease of explanation, the stiffness value of the shaft at a position 250 mm from the tip may be referred to as the “stiffness value of the tip-side portion,” the stiffness value of the shaft at the center position may be referred to as the “stiffness value of the center portion,” and the stiffness value of the shaft at a position 250 mm from the rear end of the grip may be referred to as the “stiffness value of the butt-side portion.” The flex coefficient, C/B value and T/C value can be calculated from this three-point stiffness. The C/B value is the ratio of the stiffness value of the center portion to the stiffness value of the butt portion. The T/C value is the ratio of the stiffness value of the tip-side portion to the stiffness value of the center portion. The flex coefficient is a numerical representation of the flex and is calculated by (stiffness value of the tip-side portion/stiffness value of the center portion)×(stiffness value of the tip-side portion/stiffness value of the butt-side portion)×100. Generally, a flex point whose flex coefficient is within the range of more than 0 to less than 15 is considered to be tip-heavy, a flex point whose flex coefficient is within the range of 15 or more to less than 20 is considered to be tip-to-mid, a flex point whose flex coefficient is within the range of 20 or more to less than 25 is considered to be mid, a flex point whose flex coefficient is within the range of 25 or more to less than 30 is considered to be mid-to-butt, and a flex point whose flex coefficient of 30 or more is considered to be butt-heavy; but the definition for the flex points should not be limited to the above description. The vibration frequency is the number of vibrations per minute measured when the golf club is vibrated with the grip end fixed and a weight (or the head) attached to the head end. Note that the characteristics of the first golf club may be determined either by directly measuring the first golf club (particularly the first shaft) or by adopting catalog values. Further, in measuring the first golf club directly, assuming that permission from the owner or the like must be obtained beforehand, if permission is granted, the first golf club may be disassembled into the head, shaft, and grip, and then the disassembled parts may be measured.

Incidentally, the characteristic values of the first golf club may be inputted into a computer, and the inputted values may be used to automatically select a second golf club in the first selection step. The automatic selection of the second golf club will be described in the section “(2) First selection step” below.

### (2) First Selection Step

In the first selection step, a second golf club having a second shaft with characteristics most similar to those of the first shaft is selected from a plurality of second golf clubs each having a second head and a second shaft with different characteristics from each other to be selected from a plurality of second shafts. The second golf clubs are golf clubs of multiple models that are currently available from the OMG shaft provider. The plurality of second shafts differ in at least flex, torque, three-point stiffness, and weight. Preferably, three or more types of second shafts each having a different three-point stiffness to each other are stocked, more preferably five or more types, and even more preferably seven or more types. Further, for the second shafts with different three-point stiffnesses, it is preferable to stock four or more second shafts with different weights, more preferably seven or more, and even more preferably ten or more. Further, for each second shaft having different three-point stiffness, it is preferable to stock four or more second shafts having different flexes, more preferably six or more, and even more preferably ten or more. Further, for the second shafts with different three-point stiffnesses, it is preferable to stock three or more second shafts with different torques, more preferably six or more. The second head is preferably the same for the plurality of second golf clubs.

Note that preferable examples of the above-described arrangement for the second shafts include a case of an arrangement in which three second shafts with different three-point stiffness are stocked, four second shafts with different weights (e.g., 40 g, 50 g, 60 g, 70 g) are stocked for the second shafts with different three-point stiffness, four second shafts with different flexes (e.g., R, SR, S, X) are stocked, and three second shafts with different torques (e.g., 3.0°, 4.5°, 6.0°) are stocked. In this case, 144 (=3×4×4×3) second shafts will be stocked. Other preferred examples include a case of an arrangement in which five second shafts with different three-point stiffness are stocked, seven second shafts with different weights (e.g., 40 g, 45 g, 50 g, 55 g, 60 g, 65 g, 70 g) are stocked for the second shafts with different three-point stiffness, six second shafts with different flexes (e.g., RR, R, SR, S, SX, X) are stocked, and six second shafts with different torques (e.g., 3.0°, 3.6°, 4.5°, 5.0°, 6.0°, 7.0°) are stocked. In this case, 1,260 (=5×7×6×6) second shafts will be stocked.

Another more preferred example is a case of an arrangement in which five second shafts with different three-point stiffnesses are stocked, ten second shafts with different weights (e.g., 35 g, 40 g, 45 g, 50 g, 55 g, 60 g, 65 g, 70 g, 75 g, 80 g) are stocked for the second shafts with different three-point stiffnesses, ten second shafts with different flexes (e.g., L, RR, R, SR1, SR2, S1, S2, SX, X, XX) are stocked, and six second shafts with different torques (e.g., 3.0°, 3.6°, 4.5°, 5.0°, 6.0°, 7.0°) are stocked.

In this case, 3,000 (=5×10×10×6) second shafts will be stocked. Note that each of the above examples is merely one possibility; based on the experience of the fitter and others, it is acceptable to thin out some of the less frequently used second shafts.

When the information on the characteristic values of the first golf club is inputted into a computer in the characteristic determination step, it is preferable to install a first database that stores information on the characteristics of the second shaft in association with the identification information of the second shaft, and a collating program in the computer or another computer that is communicatively connected to the computer. This is because executing the collating program and approximately collating the information on the characteristics of the first shaft with the first database allows for outputting identification information for a second golf club having a second shaft with characteristics that are most similar to those of the first shaft.

Note that when the information on the characteristics of the first shaft is information of numerical values such as weight, torque, three-point stiffness, flex coefficient, C/B value, T/C value, and frequency, the allowable range of the numerical values is set in advance in the collating program or the first database, and when the collating program is executed, a numerical range is defined based on the numerical values of the corresponding characteristics, and then identification information for second shafts having numerical values that fall within the defined numerical range is outputted. Also, in a case where the information on the characteristics of the first shaft is information of index values such as weight balance or flex, in the same manner as the above-described case, the allowable index values for those index values are set in advance in the collating program or the first database, and when the collating program is executed, identification information for the second shaft having the index value, which falls within the allowable range set in advance, is outputted. Note that when there are multiple numerical items, multiple index value items, or a mixture of numerical items and index value items, in executing the collating program, identification information for the second shaft having at least one of a numerical value and an index value that matches at least one of the numerical ranges and index values of all the items will be outputted. Note that when there are multiple items to be collated, it is preferable to prioritize the items to be collated.

### (3) HS Measurement Step

In the HS measurement step, the movement speed (i.e., head speed) of the second head when a golf ball (hereinafter, this may be simply referred to as “ball” or “sphere”) is hit with the second golf club selected in the first selection step is measured. Note that the movement speed of the second head can be measured, for example, using a commercially available head speed measuring device or a head speed measuring app on a portable computer such as a smartphone or the like.

Incidentally, the head speed measuring device or portable computer may be communicatively connected to the above-mentioned computer or the like, and information on the measured movement speed of the second head may be transmitted to and stored in the computer or the like, and information on the movement speed may be used to automatically determine the tentative flex of the shaft to be manufactured in the tentative flex determination step. The automatic tentative determination of the flex of the shaft to be manufactured will be described in the section “(4) Tentative flex determination step” below.

### (4) Tentative Flex Determination Step

In the tentative flex determination step, the flex of the shaft to be manufactured is tentatively determined based on the movement speed of the second head measured in the HS measurement step.

When information on the movement speed of the second head is stored in a computer in the HS measurement step, it is preferable to install a second database that stores information on the movement speed of the second head in association with information on the flex of the second shaft, and a collating program in that computer or another computer that is communicatively connected to that computer. This is because executing the collating program and collating the information on the movement speed of the second head with the second database allows for outputting the information on the flex of the second shaft.

Note that normally, if the movement speed of the second head is within the range of 36 m/sec or more to less than 39 m/sec, it is appropriate to set the flex to R, if the movement speed is within the range of 39 m/sec or more to less than 42 m/sec, it is appropriate to set the flex to SR, if the movement speed is within the range of 42 m/sec or more to less than 45 m/sec, it is appropriate to set the flex to S, and if the movement speed is 45 m/sec or more, it is appropriate to set the flex to SX or X; but the above-described determination should not be limited to the above case.

### (5) Head Trajectory Determination Step

In the head trajectory determination step, when a ball is hit with each of a plurality of second golf clubs (hereinafter referred to as “21st golf clubs”) having a flex corresponding to the flex tentatively determined in the flex tentative determination step, the trajectory of the second head of each of the 21st golf clubs (such as the club path (the angle of entry of the club head just before impact. Usually, “+” indicates that the head is coming down from the inside, and “−” indicates that the head is coming down from the outside), attack angle, launch angle (face angle just before impact), or the like) is determined. Note that the trajectory of the second head can be tracked, for example, using a commercially available head trajectory tracker (for example, such as a swing/trajectory measuring device such as Trackman, Flightscope, or Skytrack or the like), or a head trajectory tracking app on a portable computer such as a smartphone or the like. Here, the trajectories of the second heads of all 21st golf clubs may be determined, or after determining the trajectory of the second head of the first 21st golf club, the fitter may determine the trajectories of the second heads of other 21st golf clubs based on his or her own experience, or the like, and may finish determining the head trajectories when a relatively good head trajectory is obtained. For example, when the trajectory of the second head is inside-out, the fitter has the hitter hit a ball with a 21st golf club with a mid kick, a mid-to-butt kick, or a butt-heavy kick, depending on the degree of the trajectory, and will check the trajectory of the second head again, repeating this step until a relatively good result is obtained. Conversely, when the trajectory of the second head is outside-in, the fitter has the hitter hit the ball with a 21st golf club with a tip-heavy kick, tip-to-mid kick, or mid kick, depending on the degree of the trajectory, and checks the trajectory of the second head again, repeating this step until a relatively good result is obtained. Further, in checking the trajectory of the head, an upper blow or a down blow may be considered.

Incidentally, the head trajectory tracker or portable computer may be communicatively connected to the above-mentioned computer or the like, information on the measured trajectory of the second head may be transmitted to the computer or the like and stored, and the information on the measured trajectory may be used to automatically select a 22nd golf club in the second selection step. In such a case, it is necessary to associate the information on the measured trajectory of the second head with the identification information of the second golf club and store it in the computer. The automatic selection of the 22nd shaft will be described in the section “(6) Second selection step” below.

### (6) Second Selection Step

In the second selection step, one 21st golf club (hereinafter referred to as the “22nd golf club”) is selected from the plurality of 21st golf clubs based on the trajectory of the second head determined in the head trajectory determination step. In other words, in this step, a second shaft having three-point stiffness (which may be substituted by flex, flex point coefficient, T/C value, and C/B value) that is likely to suit the hitter is selected. Note that, in this step, the 22nd golf club may be selected by a fitter based on the information on the trajectory of the second head, or may be automatically selected by a computer based on the information on the trajectory of the second head.

When the 22nd golf club is selected by the fitter based on the trajectory information of the second head, it is preferable to install, in the computer, a third database that stores information such as the three-point stiffness of the second shaft of the second golf club in association with the identification information of the second golf club, and a collating program. This is because executing the collating program and collating the identification information of the 22nd golf club with this third database allows for outputting information such as the three-point stiffness of the second shaft.

Conversely, when the 22nd golf club is automatically selected by the computer based on the information on the trajectory of the second head, as described above, in the head trajectory determination step, the information on the trajectory of the second head need to be associated with the identification information of the second golf club and then be stored in the computer. It is preferable to install a fourth database that stores information on the second head trajectory in association with information on priority (the ideal head trajectory is set to a high priority) and a collating program in the computer or another computer that is communicatively connected to the computer. This is because executing the collating program and collating the information on the trajectory of the second head with the fourth database allows for outputting identification information of the second golf club, i.e., the 22nd golf club, which indicates the trajectory of the second head that is considered to be the best.

### (7) Shaft Behavior Determination Step

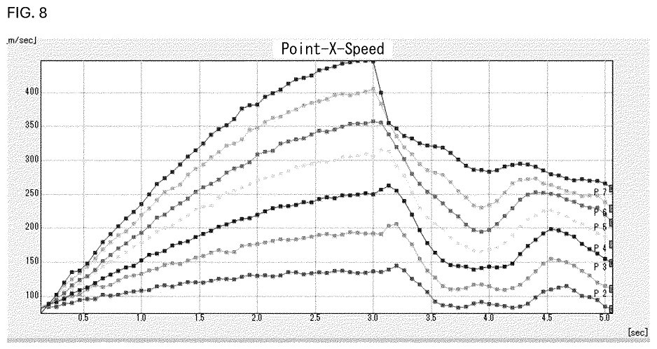

In the shaft behavior determination step, the behavior of the second shaft of the 22nd golf club (the trajectory of the second shaft over time) when a ball is hit with the 22nd golf club is determined. Note that the behavior of the second shaft can be tracked, for example, by attaching multiple motion capture sensors to the second shaft, tracking the sensors during the swing, and performing FEM analysis on the tracking data (also known as the finite element method; a method of subdividing a complex object for analysis and finding solutions for each of the subdivided areas to predict an approximate solution for the whole; the technique is applied in fields such as structural mechanics and fluid mechanics). Note that, in this step, performing the above-described processing allows for obtaining a trajectory diagram of the motion capture sensor (i.e., the second shaft) (see FIG. 7) and a graph showing the movement speed of the motion capture sensor (i.e., the second shaft) over time (see FIG. 8). In the latter graph, points where the movement speed of the motion capture sensor suddenly drops are observed, and these points are each the point of impact. Then, from the tracking data of the behavior of the second shaft in the vicinity of impact, it is possible to determine whether the timing at which the second shaft reaches its maximum speed is before the point of impact, at the point of impact, or after the point of impact (when the second shaft reaches its maximum speed before the point of impact, the speed of the motion capture sensor located closest to the head in the graph (for example, the motion capture sensor located directly above the head) will reach its maximum before the point of impact and then slow down (i.e., the curve will form a mountain shape just before the point of impact); when the second shaft reaches its maximum speed after the point of impact, the speed at the impact point of the motion capture sensor located closest to the head (for example, the motion capture sensor located directly above the head) will be slower than the speed of the second head measured in the HS measurement step). Further, from the former trajectory diagram, it is possible to determine whether the trajectory (i.e., swing) indicates a body turn type swing or a wrist turn type swing.

### (8) Shaft Specification Determination Step

In the shaft specification determination step, the specifications of the shaft to be manufactured, i.e., flex, torque, three-point stiffness, weight, shape (shape on the grip side) and center of gravity position, are determined based on the shaft behavior of the second shaft of the 22nd golf club determined in the shaft behavior determination step and the characteristic information of the 22nd golf club.

Specifically, when the timing at which the second shaft reaches its maximum speed is before the impact point, design values are determined so that the flex is stiffer than the flex of the second shaft of the 22nd golf club, taking into account the degree of this; when the timing at which the second shaft reaches its maximum speed is at the impact point, the design values are determined so that the flex is the same as the flex of the second shaft of the 22nd golf club; when the timing at which the second shaft reaches its maximum speed is after the impact point, the design values are determined so that the flex is softer than the flex of the second shaft of the 22nd golf club, taking into account the degree of this (specifically, the flex is adjusted by changing the overall stiffness without changing the flex coefficient, T/C value, and C/B value). Further, when the tracking data indicates the body turn type swing, the design values are determined taking into account the degree of the swing so that the torque is greater (looser) than the torque of the second shaft of the 22nd golf club (for example, approximately 4.5 degrees when the weight of the second shaft is 60 g or more, approximately 6 degrees when it is within the range of 50 g or more to less than 60 g, and approximately 7 degrees when it is 40 g or less); when the tracking data indicates the wrist turn type swing, the design values are determined taking into account the degree of the swing so that the torque is less (tighter) than the torque of the second shaft of the 22nd golf club (for example, approximately 3 degrees when the weight of the second shaft is 60 g or more, and approximately 4.5 degrees when it is 50 g or less). In addition, when the tracking data indicates the body turn type swing, the shape of the grip side (butt side) of the shaft may be tapered, and when the tracking data indicates a wrist turn type swing, the shape of the grip side (butt side) of the shaft may be straight. This is because, in the body turn type swing, the hitter hardly uses his wrists, so that a thinner grip is used to better catch the ball, and in the wrist turn type swing, the hitter uses his wrists, so that a thicker grip is used to prevent overuse of the wrists.

Note that when the trajectory of the ball is observed or collected as data in the head trajectory determination step, the weight of the second shaft may be adjusted depending on the trajectory of the ball. Specifically, when the degree of curvature of the hit ball is relatively large, the weight of the second shaft is increased to stabilize the directionality of the hit ball, whereas when the degree of curvature of the hit ball is approximately zero, the weight of the second shaft is decreased to improve the movement speed of the second head. Further, when the shape of the grip side (butt side) of the shaft is selected, the trajectory of the hit ball may be taken into consideration. Specifically, when the tracking data indicates the body turn type swing and the trajectory of the ball is slightly slicing, the shape of the grip side (butt side) of the shaft is made tapered, whereas when the tracking data indicates the wrist turn type swing and the trajectory of the ball is slightly hooking, the shape of the grip side (butt side) of the shaft is made straight.

In addition, the balance point of the shaft to be manufactured is adjusted depending on the club head to be attached to the shaft to be manufactured. Specifically, when the head balance is to be lighter, the balance point of the shaft to be manufactured is brought to the region of 47% to 49% closer to the tip, whereas when the head balance is to be heavier, the balance point of the shaft to be manufactured is brought to the region of 50% to 54% closer to the butt.

As described above, in this step, the flex, torque, three-point stiffness, weight, shape (shape on the grip side) and center of gravity position of the second shaft of the 22nd golf club are corrected, as described above, based on factors such as the behavior of the second shaft of the 22nd golf club and the trajectory of the ball, and then the flex, torque, three-point stiffness, weight, shape (shape on the grip side) and center of gravity position of the shaft to be manufactured are determined.

Incidentally, various characteristic values of the determined shaft to be manufactured may be inputted into a computer, and the inputted values may be used to automatically output “manufacturing specification information of a second shaft as an approximate model shaft of the shaft to be manufactured or manufacturing specification information of an already manufactured shaft,” which is required in the manufacturing specification determination step. Such automatic output of manufacturing specification information of the second shaft or the manufactured shaft will be described in the section “(9) Manufacturing specification determination step” below.

### (9) Manufacturing Specification Determination Step

In the manufacturing specification determination step, the manufacturing specifications of the shaft to be manufactured are determined based on the flex, torque, three-point rigidity, weight, shape (shape of the grip side), and center of gravity position of the shaft to be manufactured determined in the shaft specification determination step. Note that the “manufacturing specifications” referred to here include the specifications of the prepreg (for example, the type of fiber (e.g., carbon fiber, boron fiber, or the like) and resin (e.g., epoxy resin, or the like) constituting the prepreg, the area weight and shape of the prepreg, or the like), the type of core around which the prepreg is wound, the number of layers of prepreg, the layering angle of the prepreg, the method of laminating the prepreg, and the method of curing the prepreg (oven method, autoclave method, or the like, heating conditions, pressure conditions, or the like). Specifically, the information, accumulated up to the point of time, on the flex, torque, three-point stiffness, weight, shape (grip side shape) and center of gravity position of the second shaft and the OMG shafts manufactured in the past (hereinafter referred to as “manufactured shafts”) is approximately collated with information on the flex, torque, three-point stiffness, weight, shape (grip side shape) and center of gravity of the shaft to be manufactured that has been determined in the shaft specification determination step, thereby obtaining manufacturing specification information of the second shaft as an approximate model shaft of the shaft to be manufactured or an already manufactured shaft, i.e., information that serves as a standard (reference) for the manufacturing specification information of the shaft to be manufactured, and then a person who determines the manufacturing specifications corrects the manufacturing specifications based on his/her experience and rules to determine the manufacturing specifications of the shaft to be manufactured. Correcting the manufacturing specifications means, for example, changing the fibers that constitute the prepreg, or adjusting the flex and torque by changing the orientation angle of the fibers. It is preferable that the information on these manufacturing specifications is stored in a computer or the like as manufacturing specifications. Incidentally, when, as the result of the above-mentioned approximate collating, information that can serve as a standard (reference) for the manufacturing specification information of the shaft to be manufactured cannot be obtained, the person who determines the manufacturing specifications shall newly consider manufacturing specifications based on the flex, torque, three-point rigidity, weight, shape (shape of the grip side), and center of gravity position of the shaft to be manufactured that has been determined in the shaft specification determination step.

In order to easily obtain information that serves as a standard (reference) for the manufacturing specification information of the shaft to be manufactured, it is preferable to install, in the computer, a fifth database that stores the manufacturing specification information of the second shaft and the OMG shafts that have been manufactured in the past (hereinafter referred to as “manufactured shafts”) in association with information on the flex, torque, three-point stiffness, weight, shape and center of gravity position of the second shaft and the manufactured shafts, and a collating program. Note that the manufactured shafts include a model shaft for fitting (i.e., a second shaft), a manufactured OMG shaft, and the like. Then, the collating program is executed to approximately collate the information on the flex, torque, three-point rigidity, weight, shape, and center of gravity position of the shaft to be manufactured with this fifth database, thereby outputting manufacturing specification information for the second shaft or the manufactured shaft as an approximate model shaft of the shaft to be manufactured, i.e., information that serves as a standard (reference) for the manufacturing specification information of the shaft to be manufactured.

### (10) Manufacturing Step

In the manufacturing step, the shaft to be manufactured is manufactured in accordance with the manufacturing specifications of the shaft to be manufactured determined in the manufacturing specification determination step.

Note that the shaft to be manufactured, i.e., the golf shaft, can be manufactured through, for example, the following prepreg cutting step, prepreg molding step, bagging step, curing step, and demolding step. The following examples are merely examples and should not limit the present invention. In the prepreg cutting step, the prepreg is cut by a cutting machine based on the cutting data described in the manufacturing specifications (hereinafter, prepreg that has cut may be referred to as “cut prepreg”). In the prepreg molding step, while a cut prepreg is being wound around a core metal specified in the manufacturing specifications in accordance with an orientation design drawing described in the manufacturing specifications, the cut prepreg is laminated to form a prepreg shaft with the core metal. In the bagging step, the prepreg shaft with the core metal is bagged. In the curing step, the bagged prepreg shaft with the core metal is placed in an autoclave or oven, and then the prepreg shaft is subjected to a process including at least heating, the process being selected from heating and pressurizing, to cure the resin in the prepreg. In the demolding step, the core metal is removed from the cured shaft obtained by curing the resin in the prepreg, and then resin burrs adhering to the cured shaft are removed.

Note that the above-described first, second, third, fourth and fifth databases may exist independently of each other, or may be constructed as a single database.

### EXAMPLE OF A SEMI-AUTOMATIC SYSTEM USING MEASURING INSTRUMENTS AND A COMPUTER

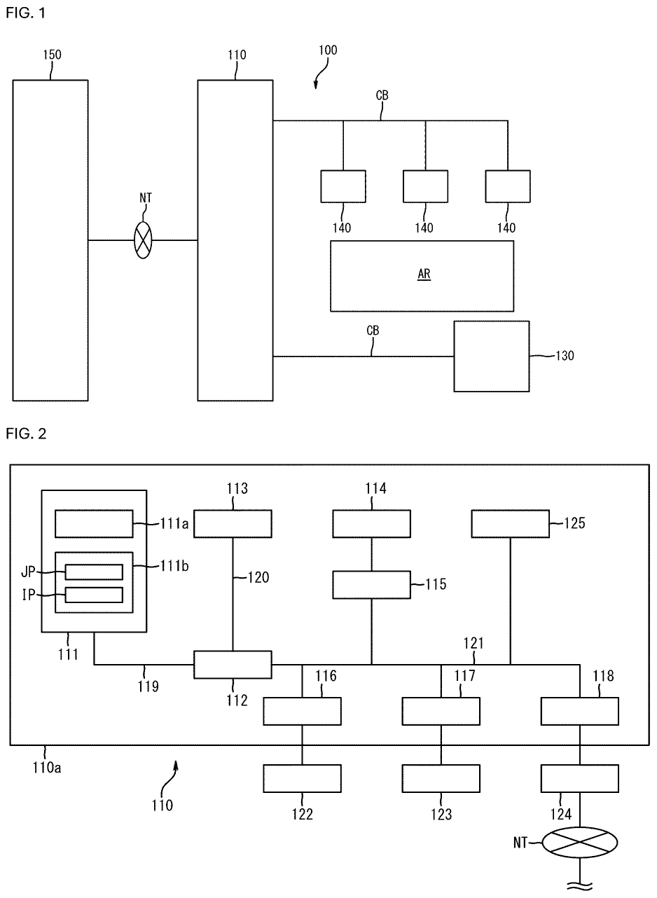

As shown in FIG. 1, a system 100 according to the present example mainly includes a first computer 110, a swing/trajectory measuring device 130, a high-speed camera 140, and a second computer 150. As shown in FIG. 1, the swing/trajectory measurement device 130 and the high-speed camera 140 are communicatively connected to the first computer 110 via a communication line CB such as a USB cable or the like. The first computer 110 is also communicatively connected to the second computer 150 via a communications network NT. Note that the first computer 110, the swing/trajectory measuring device 130 and the high-speed camera 140 are installed in a measurement room, and the second computer 150 is installed at the shaft manufacturing site. The components of the system 100, that is, the first computer 110, the swing/trajectory measuring device 130, the high-speed camera 140, and the second computer 150, will be described in detail below.

### 1. First Computer

### (1) Configuration of the First Computer

As shown in FIG. 2, the first computer 110 mainly includes a main body 110a, an input device 122, a display 123, and a communication device 124. Note that examples of the input device 122 include a keyboard, a mouse, and the like.

Examples of the communication device 124 include a network router, and the like.

As shown in FIG. 2, the main body 110a mainly includes a central processing unit 111, a main memory 113, an auxiliary memory 114, a connection unit 112, an auxiliary memory interface 115, an input interface 116, a display interface 117, a communication interface 118, and a clock signal generator 125. In the main body 110a, the central processing unit 111 is connected to the connection unit 112 via a first bus line 119, the main memory 113 is connected to the connection unit 112 via a second bus line 120, and various interfaces 115 to 118 and the clock signal generator 125 are connected to the connection unit 112 via a third bus line 121.

### (1-1) Central Processing Unit

The central processing unit 111 is, for example, a semiconductor chip called a microprocessor, and mainly includes a control unit 111a and an arithmetic unit 111b (it may also include a primary cache memory, a secondary cache memory, and the like).

The control unit 111a reads a program temporarily stored in the main memory 113, and controls the units 111b to 114, 125, and the devices 122 to 124 in accordance with the read program. The arithmetic unit 111b obtains necessary data from the main memory 113 in accordance with instructions from the control unit 111a and performs calculation processing (for example, arithmetic calculation processing, logical calculation processing, or the like).

### (1-2) Main Memory

The main memory 113 is, for example, a semiconductor chip such as a RAM (random access memory) or the like. The main memory 113 temporarily stores programs, data, or the like obtained from the auxiliary memory 114, temporarily stores data inputted via the input device 122, and temporarily stores data transmitted from the arithmetic unit 111b, communication device 124, or the like. Further, the main memory 113 transmits data or the like that is temporarily stored therein to the units 111b to 114 and/or the devices 122 to 124 that are to receive the transmitted data in accordance with instructions from the control unit 111a.

### (1-3) Connection Unit

The connection unit 112 is a semiconductor chip such as a chipset, which connects the main memory 113 and the clock signal generator 125 to the central processing unit 111, and also connects the auxiliary memory 114, the input device 122, the display 123, and the communication device 124 to the central processing unit 111 via various interfaces 115 to 118.

### (1-4) Auxiliary Memory

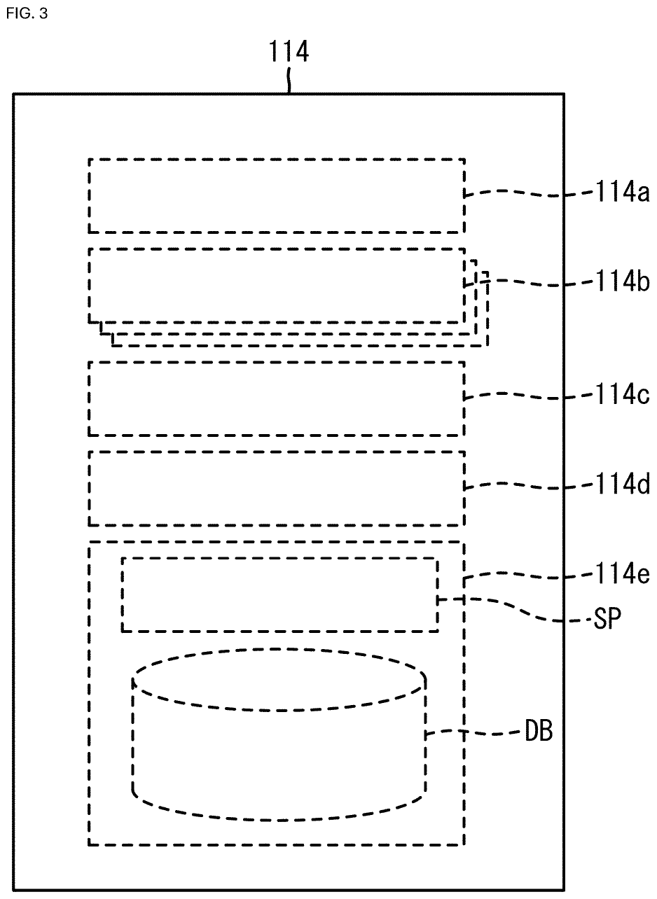

The auxiliary memory 114 is, for example, a hard disk drive, an SSD, or the like. In an embodiment of the present invention, the auxiliary memory 114 stores programs such as an operating system 114a, a device driver 114b, a swing/trajectory analysis application 114c, a motion capture application 114d, a first database application 114e, and a semi-automatic selection application 114f, as well as various data or the like, as shown in FIG. 3. The auxiliary memory 114 supplies programs, data, or the like to the main memory 113 in accordance with instructions from the control unit 111a and stores data, or the like transmitted from the main memory 113.

The auxiliary memory 114 may be an external memory.

The operating system 114a is, for example, WINDOWS (registered trademark), MACOS (registered trademark), OS/2, UNIX (registered trademark) (for example, Linux (registered trademark) or the like), BeOS (registered trademark) or the like, and performs hardware monitoring of the units 112 to 114, the various interfaces 115 to 118, the devices 122 to 124, or the like, providing a user interface, monitoring various types of data, processing common portions of applications, or the like. The device driver 114b is a dedicated program prepared for each of the auxiliary memory 114, the connection unit 112, and each of the devices 122 to 124, and serves as an intermediary for the operating system 114a to control the auxiliary memory 114, the connection unit 112, and each of the devices 122 to 124.

The swing/trajectory analysis application 114c analyzes the measurement data transmitted from the swing/trajectory measurement device 130 to the first computer 110, outputs data on the movement speed of the golf club head (i.e., head speed) when the hitter hits the golf ball with the golf club, data on the trajectory of the head (e.g., club path, attack angle, launch angle, or the like), data on the movement speed, spin amount, spin axis, or the like of the hit golf ball, and data on the trajectory of the golf ball, and then displays it on the display 123.

The motion capture application 114d analyzes multiple image data transmitted from the high-speed camera 140 to the first computer 110, outputs data on the movement of the motion capture sensor in the image data, and then displays it on the display 123. Of course, here, a plurality of motion capture sensors are attached along the longitudinal direction of the shaft.

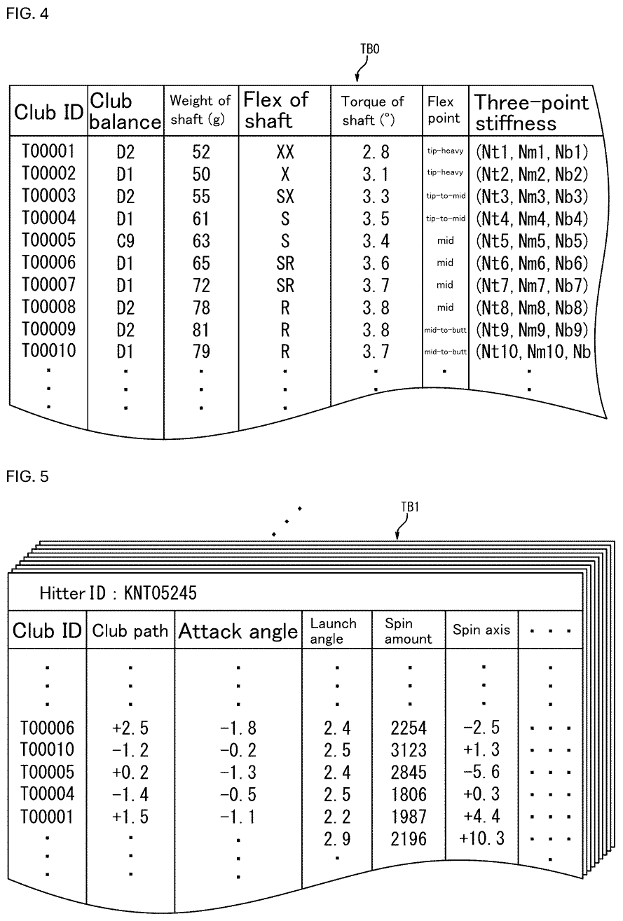

As shown in FIG. 3, the first database application 114e mainly includes a first data collation module SP and a first database DB. In the first database DB, mainly, a second golf club characteristic information management table TB0 (see FIG. 4) and a hitter-specific head trajectory information management table TB1 (see FIG. 5) are created.

The second golf club characteristic information management table TB0 is a so-called master table; in this second golf club characteristic information management table TB0, as shown in FIG. 4, club ID data, weight balance data, weight data, flex data, torque data, flex data, three-point stiffness data, flex coefficient data, C/B value data, T/C value data, and frequency data of the club, and weight data, volume data and center of gravity position data, or the like of the second head are stored in association with each other on a row basis. Note that the above-described data has been entered in advance by the service provider. The club ID data is data of an identification number unique to the second golf club that has been assigned to the second golf club by the service provider.

The hitter-specific head trajectory information management table TB1 is a table group including a plurality of tables provided for each hitter ID, as shown in FIG. 5. In the hitter-specific head trajectory information management table TB1, the club ID data, club path data, attack angle data, launch angle data, spin amount data, or the like of the second golf club are stored in association with each other on a row basis. Note that the club ID data is inputted by a fitter or the like, and other data is transmitted from the swing/trajectory measuring device 130.

The semi-automatic selection application 114f mainly includes a first selection module, a flex selection module, a second selection module, and a shaft specification determination module. These modules will be described in detail below.

The first selection module is launched simultaneously with the launch of the semi-automatic selection application 114f, and firstly displays an input screen on the display 123 of the first computer 110 to prompt the user (e.g., the employer of the fitter, or the like) of the first computer 110 to input characteristic data of the first shaft.

Then, when the user has finished inputting the characteristic data of the first shaft using the input device 122 (for example, when the fitter or the like presses a button or the like indicating that input is complete), the first selection module approximately collates the characteristic data of the first shaft with the second golf club characteristic information management table TB0 via the first data collation module SP, selects the club ID data of a second golf club having a second shaft with characteristic data that most closely resembles the characteristic data of the first shaft, and then displays it on the display 123. This display allows the fitter or other person to determine the second golf club to be used immediately after the first golf club. Note that examples of approximate collation methods include a method in which, for character data such as flex, the character data and its preceding and following character data are set in advance, and club ID data of a second golf club having a second shaft that exactly (perfectly) matches the character data is selected; for numerical data such as weight, torque, flex, three-point stiffness, flex coefficient, C/B value, T/C value, and frequency, examples of approximate collation methods include (i) a method including calculating the difference between each characteristic data of the first shaft and each characteristic data of the second shaft and then selecting club ID data of a second golf club having a second shaft with the smallest difference, (ii) a method including setting a collating range for each characteristic data, applying the collating range to the characteristic data of the first shaft, and selecting club ID data of a second golf club having a second shaft that falls within the collating range (when multiple second shafts are selected at the beginning of collating, the collating range to be set is gradually narrowed until one second shaft is finally selected), and the like. Note that when both character data and numeric data are subject to approximate collating, for the character data, exact matching may be employed, whereas for the numeric data, the above-described approximate collation method (i) or (ii) may be employed. In the latter approximate collation method (ii), priorities may be set for the characteristic data, and collating may be performed in stages based on the priorities. Additionally, the match rate with respect to the first shaft and the like may be displayed on the display 123 together with the club ID data of the second golf club.

The flex selection module has a selection table that associates the flex data of the second shaft with the movement speed of the second head; when the movement speed of the second head is determined in the swing/trajectory analysis application 114c, the flex selection module collates the movement speed of the second head with the above-mentioned selection table to output the flex data of the second shaft, and then displays it on the display 123. This display allows the fitter or the like to determine a plurality of second golf clubs of the displayed flex that should be handed to the hitter next.

When the required amount of trajectory data for the second head has been accumulated in the hitter-specific head trajectory information management table TB1 (for example, when a fitter or the like presses a button or the like after being convinced that all or a sufficient amount of trajectory data for the second head has been collected), the second selection module collates each piece of trajectory data for the second head with the initially set ideal data, then selects the club ID data of the second golf club having the second head with trajectory data that most closely approximates the ideal data, and displays it on the display 123. Note that examples of approximate collation methods include (i) a method including calculating the difference between each trajectory data of the second head and the ideal data and then selecting the club ID data of the second golf club having the second head with the smallest difference, (ii) a method of setting a collating range for the ideal data and selecting the club ID data of the second golf club having trajectory data that falls within the collating range (when multiple second golf clubs are selected at the beginning of collating, the collating range to be set is gradually narrowed until one second golf club is finally selected), (iii) a method of selecting the club ID data of the second golf club having trajectory data that is closest to the ideal data in a diagrammatic manner from among the trajectory data if the trajectory data can be displayed as a line on a coordinate system, and the like. In the approximate collating method (ii), a priority may be set for each of the different types of trajectory data, and collating may be performed in stages based on the priority. Additionally, the match rate with respect to the ideal data may be displayed on the display 123 together with the club ID data of the second golf club.

The shaft specification determination module outputs the specifications of the shaft to be manufactured, i.e., flex, torque, three-point stiffness, weight, shape (shape of the grip side) and center of gravity position, from the tracking data of the behavior of the second shaft of the 22nd golf club obtained by the motion capture application 114d and the characteristic data of the 22nd golf club. Specifically, as described above, when the second shaft reaches its maximum speed before the impact point, a positive flex correction value corresponding to the difference is added to the flex of the second shaft of the 22nd golf club, and the result is used as the flex of the shaft to be manufactured; when the second shaft reaches its maximum speed at the impact point, the flex of the second shaft of the 22nd golf club is used as the flex of the shaft to be manufactured; and when the second shaft reaches its maximum speed after the impact point, a negative flex correction value corresponding to the difference is added to the flex of the second shaft of the 22nd golf club, and the result is used as the flex of the shaft to be manufactured. Further, when the tracking data matches a pattern indicating the body turn type swing, a positive torque correction value corresponding to the degree of match is added to the torque of the second shaft of the 22nd golf club and the result is used as the torque of the shaft to be manufactured; and when the tracking data matches a pattern indicating the wrist turn type swing, a negative torque correction value corresponding to the degree of match is added to the torque of the second shaft of the 22nd golf club and the result is used as the torque of the shaft to be manufactured. Further, when the tracking data matches a pattern indicating the body turn type swing, text data indicating that the shape of the grip side (butt side) of the shaft should be tapered is outputted; and when the tracking data matches a pattern indicating the wrist turn type swing, text data indicating that the shape of the grip side (butt side) of the shaft should be straight is outputted.

Incidentally, when the shaft specification determination module outputs the specifications of the shaft to be manufactured, i.e., data on flex, torque, three-point stiffness, weight, shape (shape of the grip side), and center of gravity position, the user of the first computer 110 sends the output to the second computer 150. Note that when the shaft specification determination module outputs the specifications of the shaft to be manufactured, i.e., data on flex, torque, three-point stiffness, weight, shape (shape of the grip side) and center of gravity position, the output may be automatically sent to the second computer 150.

### (1-5) Interface

Auxiliary memory interface 115 connects the auxiliary memory 114 to the connection unit 112. The input interface 116 is, for example, an interface such as PS/2, USB, IEEE1212, RS232, IrDA (Infrared Data Association), or the like, and connects the input device 122 such as a keyboard, mouse or the like for inputting data to the main memory 113. The display interface 117 is an interface such as an AGP (Accelerated Graphics Port), PCI (Peripheral Component Interconnect), RS232, or the like, and connects the display 123 such as a CRT display, a liquid crystal display, a plasma display, or the like for displaying data transmitted from the main memory 113 as characters or images. The communication interface 118 connects the communication device 124 for establishing a communication connection to the communication network NT.

### (2) Swing/Trajectory Analysis Using a Swing/Trajectory Analysis Application

The swing/trajectory analysis application 114c performs processing on the various measurement signals and measurement data transmitted from the swing/trajectory measurement device 130, outputs data on the movement speed of the golf club head (i.e., head speed), data on the trajectory of the head (e.g., club path data, attack angle data, launch angle data, or the like), data on the movement speed of the hit golf ball, spin amount data, spin axis data, trajectory data of the golf ball, or the like, and displays such data graphically on the display 123. Further, the swing/trajectory analysis application 114c registers the head trajectory data for each of the plurality of second golf clubs in the hitter-specific head trajectory information management table TB1 in the first database DB.

### (3) Determination of Shaft Behavior Using a Motion Capture Application

As described above, the motion capture application 114d analyzes the image data transmitted from the high-speed camera 140, outputs data on the movement of the motion capture sensor in the image data, and displays it graphically on the display 123 (see FIG. 7). The motion capture application 114d also analyzes the data and displays a graph of the movement speed of the motion capture sensor over time on the display 123 (see FIG. 8).

### 2. Swing/Trajectory Measurement Device 130

The swing/trajectory measuring device 130 corresponds to the head speed measuring device and/or the head trajectory tracking device described above, and is used to measure the movement speed of the golf club head (i.e., head speed) when the hitter hits a golf ball with the golf club, determine the trajectory of the head (e.g., club path, attack angle, launch angle, or the like), measure the movement speed, spin amount, and spin axis of the hit golf ball, and/or determine the trajectory of the golf ball. Examples of such a swing/trajectory measuring device 130 include products from Trackman, Flightscope, Skytrak, and the like.

The swing/trajectory measuring device 130 is usually placed behind the hitter, that is, on the opposite side to the direction in which the golf ball is hit.

Further, as described above, the swing/trajectory measurement device 130 is communicatively connected to the first computer 110 via the communication line CB, and transmits measurement signals and measurement data to the first computer 110 for each measurement.

### 3. High-Speed Camera

The high-speed camera 140 is also called a high speed camera, and is usually positioned above, behind (i.e., opposite side of the golf ball's launch direction), and to the side (the side on which the golf ball is located when the hitter addresses the ball) of the hitter, and transmits image data to the second computer 150 after each image capture. As described above, the still image data and video data transmitted from the high-speed camera are analyzed by the motion capture application 114d installed on the first computer 110. As described above, in order to analyze the motion of an object using the motion capture application 114d, it is necessary to attach a motion capture sensor to the object.

### 4. Second Computer

The second computer 150 is a computer similar to the first computer 110, and is communicatively connected to the first computer 110 via the communications network NT as described above. Note that the second computer 150 is identical to the first computer 110, except that it has a second database application (not shown) and a manufacturing specification derivation application (not shown) installed instead of the swing/trajectory analysis application 114c, the motion capture application 114d, and the first database application 114e.

The second database application mainly includes a second data collation module (not shown) and a second database (not shown). In this second database, a manufacturing history table TB2 is mainly created.

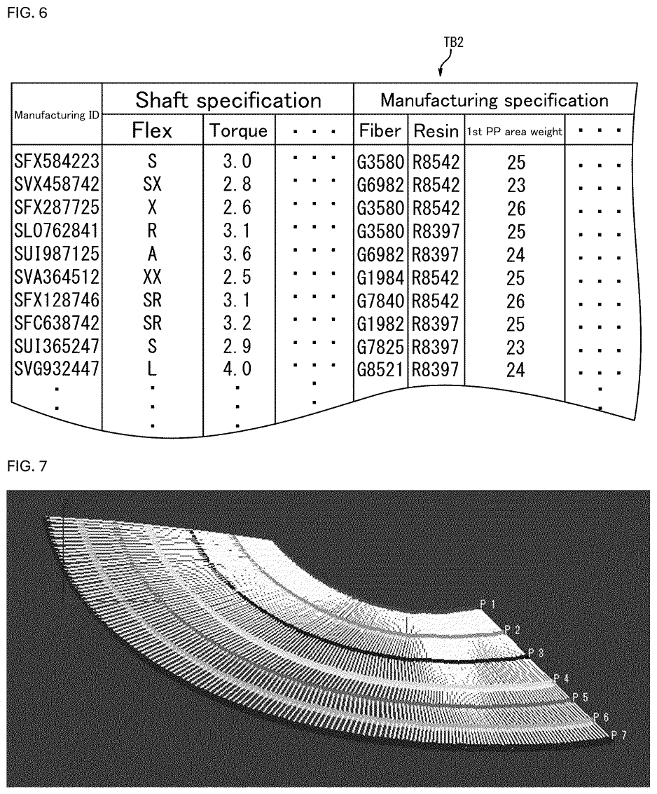

As shown in FIG. 6, the manufacturing history table TB2 stores the manufacturing specification data of the second shaft and the manufactured shaft, as well as the data on the flex, torque, three-point stiffness, weight, shape, and center of gravity position of the shaft, in association with each other on a row basis.

The manufacturing specification derivation application approximately collates the specifications of the shaft to be manufactured, which have been outputted by the shaft specification determination module of the first computer 110, i.e., the data on flex, torque, three-point stiffness, weight, shape (shape on the grip side), and center of gravity position, with the manufacturing history table TB2 via the second data collation module, selects a second shaft or an already manufactured shaft having specification data that most closely approximates the specification data of the shaft to be manufactured, and then displays that manufacturing specification data on the display. Here, examples of approximate collation methods include a method in which, for character data such as flex, the character data and its preceding and following character data are set in advance, and a second shaft or already manufactured shaft that exactly (perfectly) matches the character data is selected; for numerical data such as weight, torque, flex point, three-point stiffness, flex point coefficient, C/B value, T/C value, and frequency, examples of approximate collation methods include (i) a method including calculating the difference between each specification data of the shaft to be manufactured and each specification data of the second shaft and the already manufactured shaft, and then selecting a second shaft and an already manufactured shaft with the smallest difference, (ii) a method including setting a collating range for each specification data of the shaft to be manufactured, applying the collating range to each specification data of the shaft to be manufactured, and selecting a second shaft or an already manufactured shaft that falls within the collating range (when multiple second shafts or already manufactured shafts are selected at the beginning of collating, the collating range to be set is gradually narrowed until one second shaft or already manufactured shaft is finally selected), and the like. Note that when both character data and numeric data are subject to approximate collating, for the character data, exact matching may be employed, whereas for the numeric data, the above-described approximate collation method (i) or (ii) may be employed. In the latter approximate collation method (ii), priority may be set for the specification data, and collating may be performed in stages based on the priority. In addition, the match rate with respect to the shaft to be manufactured may be displayed on the display together with the manufacturing specification data of the second shaft or the manufactured shaft.

A person who determines the manufacturing specifications checks the manufacturing specification data displayed on the display, and then corrects the manufacturing specification data based on his or her experience and rules to determine the manufacturing specifications of the shaft to be manufactured. Note that when there are technical general rules or rules of thumb that bridge the gap between the specification items of the shaft to be manufactured and the specification items of the second shaft or the shaft that has already been manufactured, incorporating these general rules or rules of thumb into the manufacturing specification derivation application allows for automatically outputting the manufacturing specification data of the shaft to be manufactured from the specification data of the shaft to be manufactured.

Incidentally, the flex point (three-point stiffness, or the like) and the flex depend mainly on the number of prepreg layers and the modulus of elasticity of the fibers in the prepreg, or the like, whereas the torque depends mainly on the number of prepreg layers, the modulus of elasticity of the fibers in the prepreg, and the orientation angle of the fibers between the prepregs (i.e., the flex point (three-point stiffness, or the like) and flex can be adjusted by changing the modulus of elasticity of the fibers in the second shaft or the manufactured shaft, whereas the torque can be adjusted by changing at least one of the modulus of elasticity and the orientation angle of the fibers in the second shaft or the manufactured shaft). Thus, in the above-described approximate collating, the flex point (such as three-point stiffness) and the flex, as well as the torque, may be collated separately, consequently, separate manufacturing specification data for the second shaft or the manufactured shaft may be selected for the above-described two types of the shaft specifications. However, even in such cases, the mass of the shaft must be the same, so that in the above-mentioned approximate collating, it is preferable to collate the “mass, flex point (three-point stiffness, or the like), and flex of the shaft to be manufactured” and the “mass and torque of the shaft to be manufactured” separately, and then select the manufacturing specification data of a second shaft or an already manufactured shaft with the same mass. Note that it is preferable to incorporate this general rule into the manufacturing specification derivation application, thereby automatically outputting manufacturing specification data of a shaft to be manufactured from the specification data of the shaft to be manufactured.

### FEATURES OF THE SYSTEM ACCORDING TO THE ABOVE EXAMPLES

In the system 100 according to the above examples, the specifications of a golf shaft (a shaft to be manufactured) that is likely to suit an individual golf player can be semi-automatically determined through the above-described steps, and then manufacturing specification data for that golf shaft can be derived from the specification data (i.e., characteristic data) of that golf shaft. Thus, utilizing this manufacturing method allows for efficiently manufacturing golf shafts that are likely to suit individual golf players without spending a lot of time and effort on test shots, or the like, and without excessive trial and error in manufacturing golf shafts.

### MODIFICATIONS

(A)

In the previous examples, the system 100 is provided with the first computer 110 and the second computer 150; however, when the manufacturing site has a measurement room, the second database application of the second computer 150 may be integrated into the first database application 114e and the second computer 150 may be removed. In other words, in this system 100, a series of processes according to the previous examples can be performed by a single computer.
(B)

In the system 100 according to the previous examples, the manufacturing history table TB2 of the second computer 150 stores the manufacturing specification data of the second shaft and the manufactured shaft, and the data on the flex, torque, three-point stiffness, weight, shape and center of gravity position of the shaft, in association with each other on a row basis; however, the manufacturing specification data of only the manufactured shaft, and the data on the flex, torque, three-point stiffness, weight, shape and center of gravity position of the shaft, in association with each other on a row basis, may also be stored.

### INDUSTRIAL APPLICABILITY

The method for manufacturing a custom-made golf shaft according to the present invention has the advantage of being able to efficiently provide golf shafts that are likely to suit individual golf players without requiring a great deal of effort and time for test shots, or the like, and thus can contribute to the development of the golf club industry.

1. A method for manufacturing a custom-made golf shaft, comprising:
a characteristic determination step of determining a characteristic of a first shaft of a first golf club having the first shaft;
a first selection step of selecting a second golf club having a second shaft having characteristics most similar to those of the first shaft from a plurality of second golf clubs having second heads and second shafts having characteristics different from each other;
an HS measurement step of measuring a movement speed of the second head when a golf ball is hit with the second golf club selected in the first selection step;
a tentative flex determination step of tentatively determining a flex of a shaft to be manufactured based on the movement speed of the second head measured in the HS measurement step;
a head trajectory determination step of determining a trajectory of the second head of each of a plurality of second golf clubs, as 21st golf clubs, when the golf ball is hit with each of the plurality of second golf clubs each having a flex corresponding to the flex tentatively determined in the flex tentative determination step,
a second selection step of selecting one 21st golf club, as a 22nd golf club, from the plurality of 21st golf clubs based on the trajectory of the second head determined in the head trajectory determination step;
a shaft behavior determination step of determining a behavior of the second shaft of the 22nd golf club when a golf ball is hit with the 22nd golf club;
a first determination step of determining the flex, torque, three-point stiffness, weight, shape and center of gravity position of the shaft to be manufactured based on the behavior of the second shaft of the 22nd golf club determined in the shaft behavior determination step and characteristic information of the 22nd golf club; and
a manufacturing step of manufacturing the shaft to be manufactured using the information on the flex, torque, three-point stiffness, weight, shape, and center of gravity position of the shaft to be manufactured determined in the first determination step.

2. The method for manufacturing a custom-made golf shaft according to claim 1, further comprising:
an input step of inputting information on the characteristics of the first golf club determined in the characteristic determination step into a computer,
wherein in the first selection step, information on the characteristics of the first shaft is approximately collated with a first database that stores information on the characteristics of the second shaft in association with identification information of the second shaft, thereby outputting identification information of a second golf club having a second shaft with characteristics most similar to those of the first shaft.

3. The method for manufacturing a custom-made golf shaft according to claim 1, wherein
in the HS measurement step, information on the movement speed of the second head is stored in a storage device, and
in the tentative flex determination step, the information on the movement speed is collated with a second database that stores information on a range of the movement speed in association with the information on the flex, thereby outputting the information on the flex of the shaft to be manufactured.

4. The method for manufacturing a custom-made golf shaft according to claim 1, wherein
in the second selection step, the identification information of the 22nd golf club is collated with a third database that stores information on the three-point stiffness of the second shaft in association with identification information of the second golf club, thereby outputting the information on the three-point stiffness of the shaft to be manufactured.

5. The method for manufacturing a custom-made golf shaft according to claim 1, further comprising:
a third selection step in which information on the flex, torque, three-point stiffness, weight, shape and center of gravity position of the shaft to be manufactured is approximately collated with a fourth database that stores manufacturing information on the second shaft and a custom-made golf shaft manufactured in the past (hereinafter referred to as “manufactured golf shaft”) in association with information on the flex, torque, three-point stiffness, weight, shape and center of gravity position of the second shaft and the manufactured golf shaft, thereby outputting manufacturing information on the second shaft or the manufactured golf shaft as an approximate model shaft of the shaft to be manufactured; and
a second determination step of determining a method of manufacturing the shaft to be manufactured by using manufacturing information of the second shaft or the manufactured golf shaft as an approximate model shaft of the shaft to be manufactured;
wherein in the manufacturing step, the shaft to be manufactured is manufactured based on the method of manufacturing the shaft to be manufactured determined in the second determination step.

6. (canceled)

7. The method for manufacturing a custom-made golf shaft according to claim 2, wherein
in the HS measurement step, information on the movement speed of the second head is stored in a storage device, and
in the tentative flex determination step, the information on the movement speed is collated with a second database that stores information on a range of the movement speed in association with the information on the flex, thereby outputting the information on the flex of the shaft to be manufactured.

8, The method for manufacturing a custom-made golf shaft according to claim 2, wherein
in the second selection step, the identification information of the 22nd golf club is collated with a third database that stores information on the three-point stiffness of the second shaft in association with identification information of the second golf club, thereby outputting the information on the three-point stiffness of the shaft to be manufactured.

9. The method for manufacturing a custom-made golf shaft according to claim 3, wherein
in the second selection step, the identification information of the 22nd golf club is collated with a third database that stores information on the three-point stiffness of the second shaft in association with identification information of the second golf club, thereby outputting the information on the three-point stiffness of the shaft to be manufactured.

10. The method for manufacturing a custom-made golf shaft according to claim 2, further comprising:
a third selection step in which information on the flex, torque, three-point stiffness, weight, shape and center of gravity position of the shaft to be manufactured is approximately collated with a fourth database that stores manufacturing information on the second shaft and a custom-made golf shaft manufactured in the past (hereinafter referred to as “manufactured golf shaft”) in association with information on the flex, torque, three-point stiffness, weight, shape and center of gravity position of the second shaft and the manufactured golf shaft, thereby outputting manufacturing information on the second shaft or the manufactured golf shaft as an approximate model shaft of the shaft to be manufactured; and
a second determination step of determining a method of manufacturing the shaft to be manufactured by using manufacturing information of the second shaft or the manufactured golf shaft as an approximate model shaft of the shaft to be manufactured;
wherein in the manufacturing step, the shaft to be manufactured is manufactured based on the method of manufacturing the shaft to be manufactured determined in the second determination step.

11. The method for manufacturing a custom-made golf shaft according to claim 3, further comprising:
a third selection step in which information on the flex, torque, three-point stiffness, weight, shape and center of gravity position of the shaft to be manufactured is approximately collated with a fourth database that stores manufacturing information on the second shaft and a custom-made golf shaft manufactured in the past (hereinafter referred to as “manufactured golf shaft”) in association with information on the flex, torque, three-point stiffness, weight, shape and center of gravity position of the second shaft and the manufactured golf shaft, thereby outputting manufacturing information on the second shaft or the manufactured golf shaft as an approximate model shaft of the shaft to be manufactured; and
a second determination step of determining a method of manufacturing the shaft to be manufactured by using manufacturing information of the second shaft or the manufactured golf shaft as an approximate model shaft of the shaft to be manufactured;
wherein in the manufacturing step, the shaft to be manufactured is manufactured based on the method of manufacturing the shaft to be manufactured determined in the second determination step.

12. The method for manufacturing a custom-made golf shaft according to claim 4, further comprising:
a third selection step in which information on the flex, torque, three-point stiffness, weight, shape and center of gravity position of the shaft to be manufactured is approximately collated with a fourth database that stores manufacturing information on the second shaft and a custom-made golf shaft manufactured in the past (hereinafter referred to as “manufactured golf shaft”) in association with information on the flex, torque, three-point stiffness, weight, shape and center of gravity position of the second shaft and the manufactured golf shaft, thereby outputting manufacturing information on the second shaft or the manufactured golf shaft as an approximate model shaft of the shaft to be manufactured; and
a second determination step of determining a method of manufacturing the shaft to be manufactured by using manufacturing information of the second shaft or the manufactured golf shaft as an approximate model shaft of the shaft to be manufactured;
wherein in the manufacturing step, the shaft to be manufactured is manufactured based on the method of manufacturing the shaft to be manufactured determined in the second determination step.
